(19) United States
(12) Patent Application Publication
(10) Pub. No.: US 2012/0266390 A1
(43) Pub. Date: Oct. 25, 2012

(54) Laundry Fragrance Pouches, Kits, and Methods

(76) Inventor: Jonathan Propper, Haverford, PA (US)

(21) Appl. No.: 13/446,119

(22) Filed: Apr. 13, 2012

Related U.S. Application Data
(60) Provisional application No. 61/477,782, filed on Apr. 21, 2011.

(51) Int. Cl. B65D 85/00; D06L 1/16; C11B 9/00

(52) U.S. Cl. 8/137; 512/1; 206/525

(57) ABSTRACT

Water soluble pouches containing an essential oil that can be added to a load of laundry to impart a desired scent to the materials being washed, or to control the relative strength of the scent applied to the materials being washed, are provided. Also provided are kits including pouches, as well as methods for using such pouches for cleaning or scenting laundry.

### CROSS REFERENCE TO RELATED APPLICATIONS

This application claims priority to U.S. Provisional Application No. 61/477,782, filed on Apr. 21, 2011, the contents of which are incorporated by reference herein, in their entirety and for all purposes.

### FIELD OF THE INVENTION

The invention relates generally to household cleaning supplies. More particularly, the invention relates to water soluble pouches containing a liquid fragrance that can be added to a load of laundry in order to add a desired scent to the materials being washed, or to control the relative strength of the scent applied to the materials being washed, as well as kits containing such pouches and methods for using them.

### BACKGROUND OF THE INVENTION

Various publications, including patents, published patent applications, technical articles, and scholarly articles, are cited throughout the specification. Each of these cited publications is incorporated by reference in this document, in its entirety and for all purposes.

Many individuals are highly sensitive to fragrances, particularly those emitted by chemicals and perfumes added to various consumer products, including laundry detergent. Such individuals may experience allergic reactions, headaches, respiratory distress, and skin irritations, among other symptoms. Other individuals simply dislike certain fragrances, or even if they like a certain fragrance, would prefer weaker redolence, particularly from their clothing. Still other individuals may prefer more natural fragrances over perfumes and synthetic scents, or may prefer more natural and environmentally-friendly laundry detergents that do not include chemical perfumes.

Some individuals prefer strong fragrances. In some cases, such individuals may add, or at least desire to add, larger amounts of detergent to their laundry because laundry detergents typically include fragrances. But some of these individuals, who may otherwise add larger amounts of detergent to their laundry, actually do not add larger amounts of detergent because of the high cost of detergent, because higher concentrations of detergents may damage components of the washing machine, and because higher concentrations of detergents would require larger amounts of water for removal during a rinse cycle.

A large class of consumers, then, may feel constrained by the limited selection of scent choices in commercially available laundry detergents, by the higher cost of natural detergents, by the time and effort required to create a homemade detergent having a desired scent, or by the inability to obtain stronger scents in their laundry materials without having to use excess detergent. To serve such consumers, a need exists for materials that allow them to choose and/or control the level of scent in their laundry detergent.

### SUMMARY OF THE INVENTION

The invention features pouches comprising a body comprising a water-soluble material and defining a container portion, and one or more liquid fragrances, aromas, essential oils or compositions comprising one or more fragrances, aromas, or essential oils contained within the container portion. The container portion preferably has a single layer having an internal surface contacting the one or more fragrances, aromas, essential oils or compositions and having an external surface which is an outermost portion of the pouch, although the container portion may have more than one layer, such as an outer layer, which may be a coating. In some preferred aspects, the pouch has no external coating.

The composition preferably comprises about 1% to about 5% of the one or more fragrances, aromas, or essential oils, and less than about 8% of water, measured according to the weight of composition. The pouch preferably does not contain any cleaning agents such as detergents. The pouch is preferably made from polyvinyl alcohol. In preferred aspects, the composition comprises about 1% to about 3% of the one or more fragrances, aromas, or essential oils, measured according to the weight of the composition. The composition may comprise a carrier, which may comprise a hydrophobic vehicle such as an alcohol, which may be a polyol such as a glycol, and preferably is hexylene glycol or propylene glycol. The composition preferably does not contain any cleaning agent such as a detergent. The composition may further comprise one or more of a buffering agent, an antimicrobial agent, or a dye.

The invention also features laundry kits comprising one or more pouches comprising a body comprising a water-soluble material and defining a container portion, one or more liquid fragrances, aromas, essential oils, or compositions comprising one or more fragrances, aromas, or essential oils, and instructions for using the one or more pouches in a method for imparting a scent into laundry or instructions for using the one or more pouches in a method for cleaning laundry. The composition preferably comprises about 1% to about 5% of the one or more fragrances, aromas, or essential oils, and less than about 8% of water, measured according to the weight of composition. The composition may comprise a carrier, which may comprise a hydrophobic vehicle such as an alcohol, which may be a polyol such as a glycol, and preferably is hexylene glycol or propylene glycol. The composition may further comprise one or more of a buffering agent, an antimicrobial agent, or a dye.

In some aspects, the kits include instructions for using the one or more pouches in a high efficiency wash cycle, for using the one or more pouches in a regular wash cycle, for imparting a strong scent in laundry, or for imparting a weak scent in laundry. In preferred aspects, the pouches contain the one or more fragrances, aromas, essential oils, or compositions comprising one or more fragrances, aromas, or essential oils more fragrances, aromas, or essential oils. Preferably, such pouches do not contain any cleaning agent such as a detergent. The kits may further comprise one or more cleaning agents, one or more fabric softening agents, and/or one or more bleaching agents.

The kits may include more than one pouch, with some of the pouches having a different liquid fragrance, aroma, essential oil, or composition thereof, relative to the other pouches in the kit. Thus, in some aspects, the laundry kits may further comprise instructions for using more than one pouch. In some aspects, pouches contain a different liquid fragrance, aromas, essential oil, or composition thereof in order to combine desirable scents during use. In some aspects, pouches contain the same liquid fragrance, aromas, essential oil, or composition thereof in order to enhance the strength of the scent in the laundry during use.

The invention also features methods for imparting a scent into a material in need thereof, such as laundry, comprising adding a water-soluble pouch containing one or more liquid fragrances, aromas, or essential oils, or compositions comprising one or more fragrances, aromas, or essential oils to a volume of water such that the pouch dissolves in the water thereby creating a scented water solution, and contacting the material with the scented water solution for a period of time sufficient to impart a scent into the material. The water is preferably in the drum of a washing machine. Preferably, the pouch does not contain any cleaning agent, fabric softening agent, or bleaching agent, though such cleaning agent, fabric softening agent, and/or bleaching agent may be present in the water. The material may be laundry.

The invention also features methods for cleaning laundry, comprising contacting the laundry with a volume of water comprising one or more cleaning agents for a period of time sufficient to clean the laundry, optionally rinsing the laundry to remove the one or more cleaning agents from the laundry, adding a water-soluble pouch containing one or more liquid fragrances, aromas, or essential oils, or compositions comprising one or more fragrances, aromas, or essential oils to the water such that the pouch dissolves in the water thereby creating a scented water solution, and contacting the laundry with the scented water solution for a period of time sufficient to impart a scent into the laundry. The methods may further comprise rinsing the laundry to remove the scented water solution from the laundry. The methods may further comprise drying the laundry.

### DETAILED DESCRIPTION OF THE INVENTION

Various terms relating to aspects of the present invention are used throughout the specification and claims. Such terms are to be given their ordinary meaning in the art, unless otherwise indicated. Other specifically defined terms are to be construed in a manner consistent with the definition provided in this document.

As used in this document, the singular forms “a,” “an,” and “the” include plural referents unless expressly stated otherwise.

Laundry includes, but is not limited to, any materials to be washed or cleaned, including articles of clothing, sheets and linens, blankets, tapestries, napkins, upholstery, towels, curtains, area rugs, stuffed animals, pillows, footware, fabrics, and other fabric-based materials.

The invention features pouches, systems, kits, and methods for imparting a desired scent into materials being washed, for example, materials being washed in a washing machine. The pouches, systems, kits, and methods may find use in various cleaning applications, for example, for imparting a scent into laundry. The pouches, systems, kits, and methods may be used to control odors in various materials, including laundry, or even in a whole room. Thus, the pouches, systems, kits, and methods may have cosmetic applications (e.g., for making a room smell pleasantly) and may have utilitarian applications (e.g., eliminating or controlling unpleasant odor in or on materials). The pouches, systems, kits, and methods may be used in household, commercial, or industrial applications.

The pouch may be fabricated out of any suitable material, and is preferably fabricated out of a water-soluble material. Thus, the pouch is preferably water soluble. Non-limiting examples of suitable materials for fabricating the pouch include polyvinyl alcohol, partially hydrolyzed polyvinyl acetate, and alginates. The materials for the pouch may be formulated to particular water-solubility specifications, including partial or complete solubility in cold, lukewarm, warm, hot, or very hot water. The pouch preferably has a single layer of suitable materials, with the internal surface of the layer in contact with the contents of the pouch and with the external surface of the layer comprising the outermost portion of the pouch. The pouch may also have multiple layers, for example, two layers. The outer layer or layers may allow the pouch to maintain its structural integrity for longer periods of time, thereby substantially dissolving and releasing its contents later in a wash cycle. In some aspects, an outer layer may be formulated to allow the pouch to withstand higher water temperatures such as those that may be used during an early cleaning cycle, thereby allowing a pouch added early to a load of laundry to last until late in the overall cleaning cycle. The pouch is preferably not coated, although the pouch may be coated in some aspects.

The pouch material preferably can withstand the water content of liquids contained within the pouch, for example, liquid fragrances, aromas, essential oils, or compositions containing fragrances, aromas, or essential oils. Preferably, the pouch material can withstand water content of about 10% or less, about 7% or less, about 5% or less, or about 2% or less in the liquid fragrances, aromas, essential oils, or compositions contained in the container portion. Yet, the pouch readily dissolves when immersed in water or aqueous cleaning solutions.

The water solubility of the pouch, including the extent and rate of dissolution, may relate, in part, to the thickness of the pouch. The thickness may be a function of the number of layers. The thickness may be a function of the amount of the materials used, and in any event should be sufficient to give the pouch a degree of mechanical strength such that the pouch can be handled by a user without rupturing, leaking, or dissolving in the user's hand. The thickness of the pouch, particularly the container portion of the pouch, may range from about 0.1 to about 2 mm, although smaller or larger thicknesses are possible. Preferred thicknesses may be about 0.2 mm, about 0.3 mm, about 0.5 mm, or about 1 mm. In some preferred aspects, the pouch is not coated with any additional materials.

In some aspects, the pouch may comprise one or more graduations for indicating a volume of a liquid fragrance, aroma, essential oil, or composition comprising a fragrance, aroma, or essential oil within the container portion. The graduations may, for example, indicate a volume of fragrance, aroma, essential oil, or composition comprising a fragrance, aroma, or essential oil for use in a regular wash cycle, for use in a high efficiency wash cycle, for imparting a strong scent into laundry, for imparting a weak scent into laundry, or for any desired use by the end user.

In some embodiments, the pouch contains a pre-determined volume of a fragrance, aroma, essential oil, or composition comprising a fragrance, aroma, or essential oil, and the pouch is sealed during manufacture. Thus, for example, a pouch may be manufactured and provided to a consumer in a ready-to-use form, and the pouch may take the form of a bag, packet, or sachet. The volume of a fragrance, aroma, essential oil, or composition comprising a fragrance, aroma, or essential oil contained within the pouch may be a volume suitable for a regular wash cycle, for a high efficiency wash cycle, for a large load cycle including load size for commercial laundromats, for imparting strong scents, for imparting weak scents, or any other volume tailored to a particular type of article being washed or for any particular consumer preferences. A ready-to-use pouch preferably does not contain any cleaning agent such as a detergent.

A pouch may be formed, for example, from one or more sheets of a packaging material or from a tubular section of such material. In some aspects, the pouch may be formed from a single folded sheet of material or from two sheets of material, sealed together at the edges, for example, with an adhesive or by heat-sealing.

A pouch may be manufactured in any suitable shape, including a substantially round, cylindrical, or rectangular shape. The pouch may be fabricated out of any suitable material, and is preferably fabricated out of a water-soluble material. Thus, a ready-to-use pouch is preferably water soluble. Non-limiting examples of suitable materials for fabricating the pouch include polyvinyl alcohol, partially hydrolyzed polyvinyl acetate, and alginates. The materials for the pouch may be formulated to particular water-solubility specifications, including partial or complete solubility in cold, lukewarm, warm, hot, or very hot water. The pouch may be prepared according to U.S. Pat. No. 6,037,319, including the materials and specifications set forth in that patent. The pouch preferably has a single layer of suitable materials, with the internal surface of the layer in contact with the contents of the pouch. The pouch may also have multiple layers, for example two layers. The outer layer or layers may allow the pouch to maintain its structural integrity for longer periods of time, thereby substantially dissolving and releasing its contents later in a wash cycle. In some aspects, an outer layer may be formulated to allow the pouch to withstand higher water temperatures such as those that may be used during an early wash cycle, thereby allowing a pouch added early to a load of laundry to last until late in the overall wash cycle.

The pouch material preferably can withstand the water content of liquids contained within the pouch, for example, liquid fragrances, aromas, essential oils, or compositions containing fragrances, aromas, or essential oils. Preferably, the pouch material can withstand water content of about 10% or less, about 7% or less, about 5% or less, or about 2% or less in the liquid fragrances, aromas, essential oils, or compositions in the container portion. Yet, the pouch readily dissolves when immersed in water or aqueous cleaning solutions.

The inventive pouches are suitable for use with any desired fragrance, aroma, essential oil, or composition comprising a fragrance, aroma, or essential oil. Non-limiting examples of scents include cherry, berry, clove, apple, pear, banana, orange, grapefruit, lemon, lime, peach, grape, lavender, lemongrass, coconut, mint, rosemary, menthol, tea tree, cedarwood, eucalyptus, litsea, mentha, cocoa, vanilla, and any other scent a consumer prefers, as well as combinations thereof.

A composition comprising a fragrance, aroma, or essential oil may comprise, in addition to the fragrance, aroma, or essential oil, a suitable carrier. The carrier may comprise a suitable hydrophobic vehicle, including an organic solvent, oil, or alcohol such as ethanol, isopropanol, or a polyol. Non-limiting examples of suitable polyols include glycol such as ethylene glycol, polyethylene glycol, 1,2-propane diol, propylene glycol, butylene glycol, neopentyl glycol, and hexylene glycol, as well as glycerol, mannitol, maltitol, sorbitol, erythritol, xylitol, glucose, fructose, lactose and erythritan. The carrier may comprise an aqueous vehicle such as water. The composition may comprise an emulsion, including an oil-in-water or water-in-oil emulsion. Preferably, the composition does not include any detergent.

The composition is preferably formulated to be compatible with the pouch, without compromising the integrity of the pouch, weakening the pouch, or dissolving the pouch over time during shelf storage. In the pouch, the composition is preferably contained within a single layer of material having an internal surface directly contacting the composition, and having an external surface which is the outside of the pouch. Though in some aspects, the pouch may also have multiple layers, for example two layers. Where multiple layers are present, the composition is preferably contained within the inner layer of material having an internal surface directly contacting the composition and an external surface in contact with an internal surface of the next layer of material.

In some aspects, a composition comprises about 0.1% to about 10%, by weight of the composition, of a fragrance, aroma, or essential oil, about 1% to about 10%, by weight of the composition, of water, and about 90% to about 99%, by weight of the composition, of a vehicle such as an alcohol, including a polyol, or glycerin.

In some aspects, a composition comprises about 1% to about 10% by weight of the composition of a fragrance, aroma, or essential oil. In some aspects, a composition comprises about 1% to about 5% by weight of the composition of a fragrance, aroma, or essential oil. In some aspects, a composition comprises about 0.5% to about 2% by weight of the composition of a fragrance, aroma, or essential oil. In some aspects, a composition comprises about 1% to about 3% by weight of the composition of a fragrance, aroma, or essential oil. In some aspects, a composition comprises about 2% to about 4% by weight of the composition of a fragrance, aroma, or essential oil. In some aspects, a composition comprises about 0.5% to about 3% by weight of the composition of a fragrance, aroma, or essential oil. In some aspects, a composition comprises about 4% to about 7% by weight of the composition of a fragrance, aroma, or essential oil. In some aspects, a composition comprises about 0.5% to about 1.5% by weight of the composition of a fragrance, aroma, or essential oil. A fragrance, aroma, or essential oil may comprise about 0.5%, about 1%, about 2%, about 3%, about 4%, about 5%, about 6%, about 7%, about 8%, about 9%, or about 10% by weight of the composition.

In some aspects, a composition comprises about 0.5% to about 8%, by weight of the composition, of water. In some aspects, a composition comprises about 1% to about 9%, by weight of the composition, of water. In some aspects, a composition comprises about 3% to about 8%, by weight of the composition, of water. In some aspects, a composition comprises about 2% to about 7%, by weight of the composition, of water. In some aspects, a composition comprises about 1% to about 5%, by weight of the composition, of water. In some aspects, a composition comprises about 4% to about 8%, by weight of the composition, of water. In some aspects, a composition comprises about 5% to about 9%, by weight of the composition, of water. In some aspects, a composition comprises about 3% to about 6%, by weight of the composition, of water. Water may comprise about 0.5%, about 1%, about 2%, about 3%, about 4%, about 5%, about 6%, about 7%, about 8%, about 9%, or about 10% by weight of the composition. Water may comprise less than about 0.5%, less than about 1%, less than about 2%, less than about 3%, less than about 4%, less than about 5%, less than about 6%, less than about 7%, less than about 8%, less than about 9%, or less than about 10% by weight of the composition.

In some aspects, a composition comprises about 92% to about 98%, by weight of the composition, of a vehicle such as an alcohol, including a polyol, or glycerin. In some aspects, a composition comprises about 94% to about 97%, by weight of the composition, of a vehicle such as an alcohol, including a polyol, or glycerin. In some aspects, a composition comprises about 91% to about 95%, by weight of the composition, of a vehicle such as an alcohol, including a polyol, or glycerin. In some aspects, a composition comprises about 92% to about 96%, by weight of the composition, of a vehicle such as an alcohol, including a polyol, or glycerin. In some aspects, a composition comprises about 91% to about 95%, by weight of the composition, of a vehicle such as an alcohol, including a polyol, or glycerin. In some aspects, a composition comprises about 95% to about 99%, by weight of the composition, of a vehicle such as an alcohol, including a polyol, or glycerin. In some aspects, a composition comprises about 95% to about 95%, by weight of the composition, of a vehicle such as an alcohol, including a polyol, or glycerin. The vehicle may comprise about 90%, about 91%, about 92%, about 93%, about 94%, about 95%, about 96%, about 97%, about 98%, or about 99% by weight of the composition. One preferred example of a suitable alcohol for the composition is hexylene glycol. One preferred example of a suitable alcohol for the composition is propylene glycol. Glycerin is another example of a suitable vehicle.

In some preferred aspects, a composition comprises about 1% to about 3%, by weight of the composition, of a fragrance, aroma, or essential oil, about 3% to about 8%, by weight of the composition, of water, and about 88% to about 96% of a vehicle such as an alcohol, including a polyol, or glycerin. The amount of fragrance, aroma, essential oil, water, and/or vehicle can vary according to the particular properties or characteristics of the fragrance, aroma, essential oil to be included in a pouch, or desired outcome for the consumer such as washed clothing with a strong or weak scent.

The composition may comprise a suitable amount of one or more surfactants, emulsifiers, suspending agents, or other agent that may solubilize the fragrance, aroma, or essential oil in an aqueous environment or carrier. Suitable surfactants include anionic, cationic, zwitterionic, and nonionic surfactant, or combinations thereof. Surfactants, if included, preferably are not present in an amount sufficient to function substantially as a detergent, but rather in an amount sufficient to solubilize an essential oil or an oil-based fragrance or aroma in an aqueous environment or carrier. The composition may comprise buffering agents, antimicrobial agents, and other agents to reduce or eliminate degradation of the composition or on the pouch. The composition may comprise a dye to give the composition a desired color. The composition may have an acidic, basic, or neutral pH.

A surfactant, emulsifier, or suspending agent may comprise about 0.1% to about 10%, by weight of the composition. For example, the surfactant, emulsifier, or suspending agent may comprise about 0.5%, about 1%, about 2%, about 3%, about 4%, about 5%, about 6%, about 7%, about 8%, about 9%, or about 10% by weight of the composition.

The buffering agent, antimicrobial agent, and/or dye may comprise about 0.05% to about 5%, by weight of the composition. For example, the buffering agent, antimicrobial agent, and/or dye may independently, or collectively in any combination comprise about 0.05%, about 0.075%, about 0.1%, about 0.25%, about 0.4%, about 0.5%, about 0.6%, about 0.75%, about 9%, about 1%, about 1.5%, about 2%, about 2.5%, about 3%, about 3.5%, about 4%, about 4.5%, or about 5% by weight of the composition.

It is preferable to limit the amount of water in the composition to less than 10% of the weight of the composition. In some aspects, it is preferable to limit the amount of water to less than about 7%, less than about 5% of the weight of the composition, less than about 3% of the weight of the composition, or less than about 2% of the weight of the composition. It is preferred that the pouch containing a composition is stable over extended periods of time of shelf storage, including at least about 6 months, at least about 9 months, at least about 12 months, at least about 15 months, at least about 18 months, or at least about 24 months, or longer. Shelf storage conditions preferably include room temperature, and low to moderate humidity.

The invention also features laundry kits. The kits may be packaged in a suitable container, for example, a box or a case.

In some aspects, the kits comprise one or more pouches, such as a pouch described or exemplified in this specification, one or more fragrances, aromas, essential oils, or compositions comprising one or more fragrances, aromas, or essential oils. and instructions for using the kit in a method for imparting a scent into laundry. In some preferred aspects, the instructions are for using the kit in a method for cleaning a material, including cleaning laundry. In some alternative aspects, the instructions are for using the kit in a method for controlling odor in a material, including laundry.

In the kits, the one or more fragrances, aromas, essential oils, or compositions comprising one or more fragrances, aromas, or essential oils may be any fragrance, aroma, essential oil, or composition comprising one or more fragrances, aromas, or essential oils, including those described or exemplified in this specification. Pouches containing different fragrances, aromas, essential oils, or compositions comprising a fragrance, aroma, or essential oil may be provided with the kit. In some aspects, the kits further include instructions for including more than one pouch in a method for cleaning a material, including cleaning laundry to obtain combinations of desirable scents, for example, lemon-lime, orange-clove, apple-vanilla, or other combinations preferred or desired by the end user.

The kits may further include one or more cleaning agents such as a detergent. The kits may further include a fabric softening agent. The kits may further include a bleaching agent. Such cleaning agents, fabric softening agents, and bleaching agents may be provided in separate water-soluble pouches, and preferably are not contained in the same pouch that contains a fragrance, aroma, essential oil, or composition comprising one or more fragrances, aromas, or essential oils.

The invention also features methods. In some aspects, the methods may be used to impart a scent into a material, including laundry. The methods may be used to control, reduce, or eliminate unpleasant odors in a material in need thereof, including laundry. The methods may be used to enhance scent in the material.

Generally, the methods comprise adding a pouch containing one or more fragrances, aromas, or essential oils, or composition comprising one or more fragrances, aromas, or essential oils to a volume of water such that exposure of the pouch to the water for a sufficient period of time causes the pouch to dissolve in the water, thereby releasing the contents of the pouch into the water and creating a scented water solution, and contacting a material in need of odor control or laundry with the scented water solution for a period of time sufficient to impart a scent into the material or laundry. In some preferred aspects, the water is in the drum of a washing machine, or is being added to the drum of a washing machine, for example, during a filling or rinse cycle. Preferably, the pouch does not contain any cleaning agent such as a detergent, or a bleaching agent, or a fabric softening agent. A material in need of odor control need not be a fabric-based material, and may be a surface such as a floor, shower stall, toilet surface, bathtub, or tile, or a container, or dinnerware. The scented water solution may be in a bucket, a spray bottle or a squirt bottle which are used to contact the material with the scented water solution. Thus, in some aspects, contacting the material in need of odor control or laundry may comprise immersing the material or laundry in the scented water solution, or spraying or squirting the material or laundry with the scented water solution.

In some aspects, the water comprises a cleaning agent, for example, a detergent such as a laundry detergent. In some aspects, the water comprises a fabric softening agent. In some aspects, the water comprises a bleaching agent. The pouch may be added to the water substantially at the same time as the cleaning agent or the fabric softening agent or the bleaching agent, or may be added to the water before or after the cleaning agent or fabric softening agent or bleaching agent is added to the water. The cleaning agent may be in a separate pouch; see, e.g., U.S. Pat. No. 6,037,319 or U.S. Publ. No. 2006/0223736.

The period of time may be measured in seconds or minutes, and may depend, for example, on a particular washing cycle, or on the temperature of the water, the degree of odor in the material, or on the number of layers of the pouch.

The pouch may include any suitable amount of the one or more fragrances, aromas, or essential oils, or composition comprising one or more fragrances, aromas, or essential oils. The amount may depend, for example, on whether the washing machine is a regular or high efficiency machine, on the size of the washing machine, on the volume of water, or on the particular preference of the user. For example, larger volumes of water may require a higher amount of the one or more fragrances, aromas, or essential oils, or composition comprising one or more fragrances, aromas, or essential oils to achieve the desired level of scent, and smaller volumes of water may require a lesser amount. A composition comprising one or more fragrances, aromas, or essential oils may be any composition described or exemplified herein. The one or more fragrances, aromas, or essential oils may be any fragrance, aroma, or essential oil, including those described or exemplified herein.

The pouch may be any pouch described or exemplified herein. The pouch may be any pouch described or exemplified in U.S. Pat. No. 6,037,319. The pouch is preferably water soluble, and prepared from materials such as polyvinyl alcohol, partially hydrolyzed polyvinyl acetate, and alginates. The pouch may be have particular water-solubility specifications, including partial or complete solubility in cold, lukewarm, warm, hot, or very hot water.

In some aspects, the methods are for cleaning laundry. Generally, the methods comprise contacting laundry with a volume of water comprising one or more cleaning agents, one or more bleaching agents, and/or one or more fabric softening agents, for a period of time sufficient to clean the laundry, optionally agitating the laundry in the water to facilitate the cleaning, optionally rinsing the laundry with a volume of water to remove the one or more cleaning agents, one or more bleaching agents, and/or one or more fabric softening agents from the laundry, adding a pouch containing one or more fragrances, aromas, or essential oils, or composition comprising one or more fragrances, aromas, or essential oils to the water such that exposure of the pouch to the water for a sufficient period of time causes the pouch to dissolve in the water, thereby releasing the contents of the pouch into the water and creating a scented water solution, contacting the laundry with the scented water solution for a period of time sufficient to impart a fragrance into the laundry, optionally agitating the laundry in the scented water solution to facilitate the imparting, and rinsing the laundry with a volume of water to remove the scented water solution from the laundry. The method may further comprise drying the laundry.

Preferably, the pouch does not contain any cleaning agent such as a detergent, or a bleaching agent, or a fabric softening agent. Preferably, the pouch is added to water in the drum of a washing machine, or water being added to the drum of a washing machine, for example, during a filling or rinse cycle.

Each period of time may be measured in seconds or minutes, and may depend, for example, on a particular washing cycle, or on the temperature of the water, or on the desired strength of scent in the laundry.

The pouch may include any suitable amount of the one or more fragrances, aromas, or essential oils, or composition comprising one or more fragrances, aromas, or essential oils. The amount may depend, for example, on whether the washing machine is a regular or high efficiency machine, on the size of the washing machine, on the volume of water, or on the particular preference of the user. For example, larger volumes of water may require a higher amount of the one or more fragrances, aromas, or essential oils, or composition comprising one or more fragrances, aromas, or essential oils to achieve the desired level of scent, and smaller volumes of water may require a lesser amount. A composition comprising one or more fragrances, aromas, or essential oils may be any composition described or exemplified herein. The one or more fragrances, aromas, or essential oils may be any fragrance, aroma, or essential oil, including those described or exemplified herein.

The pouch may be any pouch described or exemplified herein. The pouch may be any pouch described or exemplified in U.S. Pat. No. 6,037,319. The pouch is preferably water soluble, and prepared from materials such as polyvinyl alcohol, partially hydrolyzed polyvinyl acetate, and alginates. The pouch may be have particular water-solubility specifications, including partial or complete solubility in cold, lukewarm, warm, hot, or very hot water.

The invention is not limited to the embodiments described and exemplified above, but is capable of variation and modification within the scope of the appended claims.

We claim:

1. A pouch, comprising a body comprising a water-soluble material and defining a container portion containing a composition comprising about 1% to about 5% of one or more liquid fragrances, aromas, or essential oils, less than about 8% of water and about 89% to about 99% of a carrier, measured according to the weight of the composition.

2. The pouch of claim 1, wherein the container portion has a single layer having an internal surface contacting the composition and having an external surface which is an outermost portion of the pouch.

3. The pouch of claim 1, wherein the water-soluble material comprises polyvinyl alcohol.

4. The pouch of claim 1, wherein the pouch does not contain any cleaning agent.

5. The pouch of claim 1, wherein the pouch comprises a composition comprising about 1% to about 3% of one or more fragrances, aromas, or essential oils, and about 3% to about 8% of water, measured according to the weight of the composition.

6. The pouch of claim 1, wherein the carrier comprises a hydrophobic vehicle.

7. The pouch of claim 6, wherein the hydrophobic vehicle comprises hexylene glycol or propylene glycol.

8. The pouch of claim 1, wherein the carrier comprises glycerin.

9. The pouch of claim 1, wherein the composition is contained within the container portion in a volume sufficient for one high efficiency laundry cycle.

10. The pouch of claim 1, wherein the composition is contained within the container portion in a volume sufficient for one regular laundry cycle.

11. The pouch of claim 1, wherein the composition further comprises one or more of a buffering agent, an antimicrobial agent, and a dye.

12. A laundry kit, comprising one or more pouches comprising a body comprising a water-soluble material and defining a container portion containing a composition comprising about 1% to about 5% of one or more liquid fragrances, aromas, or essential oils, less than about 8% of water, and about 89% to about 99% of a carrier, measured according to the weight of the composition, and instructions for using the kit in a method for imparting a scent into laundry or instructions for using the kit in a method for cleaning laundry.

13. The laundry kit of claim 12, wherein the container portion has a single layer having an internal surface for contacting the composition and has an external surface which is an outermost portion of the pouch.

14. The laundry kit of claim 12, wherein the one or more pouches do not contain any cleaning agent.

15. The laundry kit of claim 12, wherein the one or more pouches are the pouch of claim 1.

16. A method for imparting a scent into a material in need thereof, comprising adding the pouch of claim 1 to a volume of water such that the pouch dissolves in the water thereby creating a scented water solution, and contacting the material with the scented water solution for a period of time sufficient to impart a scent into the material.

17. The method of claim 16, wherein the pouch does not contain any cleaning agent, fabric softening agent, or bleaching agent.

18. A method for cleaning laundry, comprising contacting the laundry with a volume of water comprising one or more cleaning agents for a period of time sufficient to clean the laundry, optionally rinsing the laundry to remove the one or more cleaning agents from the laundry, adding the pouch of claim 1 to the water such that the pouch dissolves in the water thereby creating a scented water solution, and contacting the laundry with the scented water solution for a period of time sufficient to impart a scent into the laundry.

19. The method of claim 18, further comprising rinsing the laundry to remove the scented water solution from the laundry.

20. The method of claim 18, further comprising drying the laundry.
